(19) United States
(12) Patent Application Publication
(10) Pub. No.: US 2012/0161442 A1
(43) Pub. Date: Jun. 28, 2012

(54) TURBINE SPEED STABILISATION CONTROL SYSTEM

(75) Inventor: Peter Chapple, Wiltshire (GB)

(73) Assignee: CHAPDRIVE AS, Trondheim (NO)

(21) Appl. No.: 13/119,186

(22) PCT Filed: Sep. 2, 2009
(86) PCT No.: PCT/NO2009/000306

§ 371 Date: May 3, 2011

Related U.S. Application Data
(60) Provisional application No. 61/097,696, filed on Sep. 17, 2008.

(30) Foreign Application Priority Data
Sep. 17, 2008 (GB) 0817027.6

(51) Int. Cl. H02P 9/06; F03D 11/02

(52) U.S. Cl. 290/44; 290/43

(57) ABSTRACT

A closed loop turbine speed control system for a turbine power production system including a closed loop hydrostatic transmission system for the transfer of energy from a wind turbine rotor to a generator. A displacement actuator is arranged for receiving a displacement control signal from the control system and for controlling a displacement of the displacement motor. The control system includes a turbine rotor speed feedback control loop for calculating the displacement control signal based on deviations of a turbine rotor actual rotational speed from a turbine rotor set rotational speed. In addition a hydraulic pressure meter measures the hydraulic pressure of the hydrostatic system and provides a hydraulic pressure signal as an input to a pressure feedback control loop for stabilizing the displacement control signal based on the hydraulic pressure signal.

The present invention relates to a control loop turbine rotational speed control system for a turbine power production system and a method for controlling a turbine rotational speed.

in embodiments, this invention relates to the control and stabilisation of the turbine speed of a turbine power production system. Closed loop speed control is required to accurately set the turbine speed and also to prevent speed oscillations that would otherwise arise under certain wind conditions. The dynamic behaviour and stability of the system is largely dependent on the level of internal leakage in the closed loop hydrostatic transmission system the effect of which is modified by the operating point of the turbine speed and torque. The invention relates more specifically to a system and a method for preventing turbine speed variations that arise due to changes in the turbine speed as a result of internal leakage in the closed loop hydrostatic transmission system used for the transfer of energy from the turbine to the generator.

### BACKGROUND ART

In conventional wind turbine power production systems the energy from the wind is transferred mechanically, either directly or by a rotational speed-up gear to an electric generator. The generator must rotate at a nominal speed to be able to deliver electricity to the grid or network connected to the power production system. If, during low wind speed conditions, the turbine is not supplying an appropriate level of mechanical torque to the system it will fail to deliver energy and instead the generator will act as an electric motor and the net will drive the generator and turbine through the mechanical gear. On the other hand, if the wind is too strong the angular speed of the wind turbine rotor may become too high for the generator to operate properly or the mechanical apparatus could break down due to the strong forces.

U.S. Pat. No. 6,911,743 describes a wind turbine power generation system comprising a main gear driven transmission for transferring wind energy to the generator. A hydraulic transmission system with variable displacement is running in parallel to the gear driven system. Both the gear driven transmission and the hydraulic transmission pump is driven by the propeller by a split gear. On the generator side the hydraulic motor varies the gear ratio of a planet gear interconnecting the mechanical transmission and the generator shaft. In order to obtain fixed rotational speed of the generator at fluctuating wind speeds, the wind speed is measured and used as an input to a controller that is able to vary the displacement of the variable displacement hydraulic motor/pump according to the measured wind speed.

It has been proposed in several publications to use a hydrostatic transmission system comprising a hydraulic pump and a hydraulic motor for transferring energy from the turbine to the generator. By employing a hydraulic pump and/or motor with variable displacement, it is possible to rapidly vary the gear ratio of the hydraulic system to maintain the desired generator speed under varying wind conditions.

In U.S. Pat. No. 4,503,673 (Schachles, 1979) the hydraulic pressure generated by the turbine pump is sensed and compared with a datum value that is varied with the velocity of the wind. If the pressure is lower than the set value, the motor displacement is increased, thus increasing the turbine speed until the actual pressure and the set pressure are equal. Thus as the wind speed is increased, so the turbine speed increases in the way that the datum value is varied with the wind velocity in order to create a constant tip speed ratio (TSR).

There are some advantages of measuring the turbine rotational speed and using this as an input to a control system according to the invention when compared to the system using pressure measurements for controlling the generator speed as described in U.S. Pat. No. 4,503,673. The advantages include:
Improved accuracy of the operating point for maximum efficiency. This is because of the low rate of variation in the hydraulic pressure with changes in turbine speed, for a given wind speed, which could cause uncertainty in its operation. It is also likely that the graphical relationship is concave upwards which could worsen this problem. Using turbine speed control the speed that creates maximum turbine efficiency can be more precisely defined.
As a result of the above and also because of the way in which the hydraulic pressure arises in the system, it is likely that there would be problems in providing an acceptable dynamic response for a pressure control system. In this event and to avoid instability, the value of system controller gain would have to be set at a level that would further compromise its steady-state accuracy.

Japanese patent application JP 11287178 describes a wind turbine power generation system comprising a hydraulic pump and a hydraulic motor in a closed loop hydrostatic system to drive an electric generator. The rotational speed of the electric generator/hydraulic motor assembly is measured and used as an input to a controller that is able to vary the displacement of the variable displacement hydraulic motor to keep the generator speed and thus output frequency stable at fluctuating wind speeds. As an alternative approach to measuring the rotational speed of the generator, JP 11287178 also describes a system where the oil-pressure in the high pressure side of the hydraulic transmission system is measured and used as an input to the controller that is able to vary the displacement of the variable displacement hydraulic motor to keep the generator speed and thus generator frequency stable at fluctuating wind speeds.

Hydrostatic transmission systems allow more flexibility regarding the location of the components than mechanical transmissions.

The relocation of the generator away from the top portion of the tower in a wind turbine power production system removes a significant part of the weight from the top portion of the tower. Instead the generator may be arranged on the ground or in the lower part of the tower. Such an arrangement of the hydrostatic motor and the generator on the ground level will further ease the supervision and maintenance of these components, because they may be accessed at the ground level.

International patent application WO-A-94/19605 by Geihard et al. describes a wind turbine power production system comprising a mast on which is mounted a propeller which drives a generator. The power at the propeller shaft is transmitted to the generator hydraulically. The propeller preferably drives a hydraulic pump which is connected by hydraulic lines to a hydraulic motor driving the generator. The hydraulic transmission makes it possible to locate the very heavy generator in a machinery house on the ground. This reduces the load on the mast and thus makes it possible to design the mast and its foundation to be lighter and cheaper.

A trend in the field of so-called alternative energy is that there is a demand for larger wind turbines with higher power. Currently 5 MW systems are being installed and 10 MW systems are under development. Especially for off-shore installations far away from inhabited areas larger systems may be environmentally more acceptable and more cost effective. In this situation the weight and maintenance access of the components in the nacelle of the wind turbines is becoming a key issue. Considering that about 30% of the downtime for a conventional wind turbine is related to the mechanical gearbox, the weight of a 5 MW generator and the associated mechanical gear is typically 50 000 to 200 000 kg and that the centre of the turbine stretches 100 to 150 m above the ground or sea level, it is easy to understand that the deployment and maintenance of conventional systems with mechanical gears and generator in the nacelle is both costly and difficult.

As opposed to conventional wind turbine systems comprising mechanical speed-up gears where the generator is arranged in the nacelle of the wind turbine power production system, the generator in the present invention may be arranged on the ground or close to the ground, as well as close to the sea surface for off-shore or near shore applications because of the flexibility of the hydraulic transmission system. The location and weight of the drive train and the generator is becoming increasingly important for the installation and maintenance as the delivered power and the size of the wind turbine is increasing.

U.S. Pat. No. 6,922,743 describes a turbine driven electric power production system and a method for controlling a turbine driven electric power production system where a turbine is driven by a fluid (wind) having a fluid speed varying in time. The turbine is connected to a hydraulic displacement pump which is connected to a hydraulic motor in a closed loop hydraulic system. The motor drives an electrical generator. A speed measurement signal (wind speed) is used as input for continuously calculating a control signal for a volumetric displacement control actuator acting on said hydraulic motor arranged for continuously adjusting a volumetric displacement of the hydraulic motor.

International patent application WO-A-20071053036 describes a turbine driven power production system with a closed loop control system arranged for maintaining the rotational speed of the electric generator and maintaining a turbine Tip Speed Ratio.

For turbines that are connected to the grid with the generator operating at synchronous speed the turbine speed can be varied by varying the displacement of the hydraulic motor. This can form part of a closed loop control of turbine speed satisfactory achievement of which requires certain algorithms to be developed in the control system

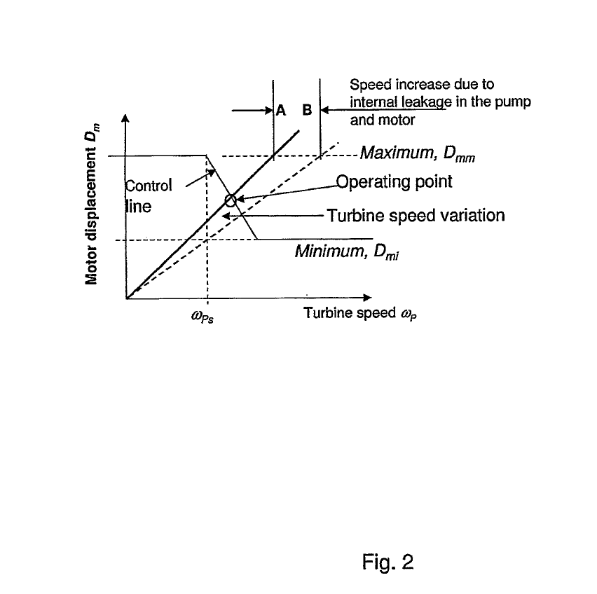

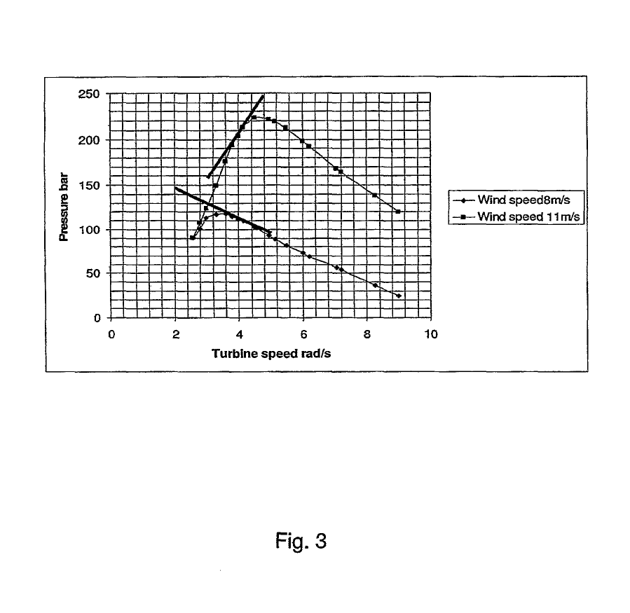

In the case where the generator is connected to the electric grid and the generator is directly driven by the hydraulic motor, e.g. the generator shaft is fixed to the shaft of the hydraulic motor, the motor operates at almost fixed rotational speed and for this situation the turbine speed can be directly related to motor displacement as shown in FIG. 2, where it is shown that normal variation of the turbine speed with motor displacement for the motor speed kept at a constant value. Consequently, for a given displacement there is a particular ideal value of turbine speed e.g. at point A for the maximum displacement condition. However, as is shown in FIG. 2, as a result of internal leakage in the pump or in the motor, this value of turbine speed will increase to point B. The level of the leakage flow is dependent on, and consequently increases with, the hydraulic pressure which itself varies with the wind and turbine speeds as shown in FIG. 3. The leakage rate also increases with the temperature of the hydraulic fluid because of the reduction in the fluid velocity. FIG. 3 also shows the pressure characteristics of the hydrostatic system in relation to the turbine speed and wind speed. As can be seen from the graphs the turbine speed giving maximum pressure (and corresponding torque) varies with the wind speed and the slope of the turbine speed/pressure curve may change from positive to negative values. This behaviour may create oscillations or undesired variations in the system leading to reduced overall efficiency and possibly mechanical wear.

### SUMMARY OF THE INVENTION

According to a first aspect of the present invention, there is provided a closed loop turbine rotational speed control system for a turbine power production system arranged for being driven by a fluid, said turbine power production system comprises a closed loop hydrostatic transmission system for the transfer of energy from a wind turbine rotor to an electric generator, wherein said hydrostatic transmission system comprises; a pump, a variable displacement motor, a displacement actuator (d) arranged for receiving a displacement control signal (ds) from said turbine speed control system and further arranged for controlling a displacement of said displacement motor based on said control signal (ds), and a hydraulic pressure meter (pm) arranged for measuring a hydraulic pressure of said hydrostatic system and providing a hydraulic pressure signal (ps), said closed loop turbine rotational speed control system comprising a turbine rotor rotational speed feedback control loop arranged for calculating said displacement control signal (ds) based on deviations of a turbine rotor actual rotational speed (ωp) from a turbine rotor set rotational speed (ωₚₛ), said closed loop turbine rotational speed control system further comprising a pressure feedback control loop arranged for stabilising said turbine rotor actual rotational speed (ωp) based on said hydraulic pressure signal (ps).

According to a second aspect of the invention, there is provided a method for controlling a turbine rotational speed (ωₚ) of a turbine power production system (1) driven by a fluid, wherein said turbine power production system comprises a closed loop hydrostatic transmission system for the transfer of energy from a wind turbine rotor to an electric generator, wherein said hydrostatic transmission system comprises a pump, a variable displacement motor and a displacement actuator (d) receiving a displacement control signal (ds) from said turbine speed control system and controlling a displacement of said displacement motor based on said control signal (ds), comprising the following steps; setting a turbine set rotational speed (ωₚₛ), measuring a turbine actual rotational speed (ωₚ) and providing a turbine actual rotational speed signal (Sωₚ), measuring a hydraulic pressure (pₘ) of said hydrostatic system and providing a hydraulic pressure signal (Sp), continuously calculating said displacement control signal (ds) based on a difference in said turbine set rotational speed (ωₚₛ) and said turbine actual rotational speed signal (Sωₚ), and continuously stabilising said turbine rotor actual rotational speed (ωp) based on said hydraulic pressure signal (ps) to stabilise said displacement control signal (ds).

According to a third aspect of the invention, there is provided a power generating assembly, comprising a turbine and a closed loop turbine rotational speed control system according to the first aspect of the invention.

In embodiments the present invention provides a method and a system for improving the stability of a turbine rotational speed closed loop control system in a turbine power production system comprising a hydrostatic transmission system by preventing speed variations that arise due to changes in turbine speed as a result of internal leakage.

In an embodiment the present invention is a closed loop turbine rotational speed control system for a turbine power production system arranged for being driven by a fluid. The turbine power production system comprises a closed loop hydrostatic transmission system for the transfer of energy from a wind turbine rotor to an electric generator, wherein said hydrostatic transmission system comprises a pump and a variable displacement motor. Further it comprises a displacement actuator arranged for receiving a displacement control signal from said turbine speed control system and for controlling a displacement of the displacement motor based on the control signal. A hydraulic pressure meter is arranged for measuring a hydraulic pressure of the hydrostatic system and providing a hydraulic pressure signal.

The closed loop turbine rotational speed control system comprises a turbine rotor rotational speed feedback control loop arranged for calculating the displacement control signal based on deviations of a turbine rotor actual rotational speed from a turbine rotor set rotational speed. The closed loop turbine rotational speed control system further comprises a pressure feedback control loop arranged for damping the displacement control signal based on the hydraulic pressure signal.

In an embodiment the invention is a method for controlling a turbine rotational speed of a turbine power production system driven by a fluid wherein the turbine power production system comprises a closed loop hydrostatic transmission system for the transfer of energy from a wind turbine rotor to an electric generator. The hydrostatic transmission system comprises a pump, a variable displacement motor and a displacement actuator receiving a displacement control signal from the turbine speed control system and controlling a displacement of the displacement motor based on the control signal. The method comprises the following steps;
setting a turbine set rotational speed,
measuring a turbine actual rotational speed and providing a turbine actual rotational speed signal,
measuring a hydraulic pressure of the hydrostatic system and providing a hydraulic pressure signal,
continuously calculating the displacement control signal based on a difference in the turbine set rotational speed and the turbine actual rotational speed signal, and
continuously modifying the displacement control signal based on the hydraulic pressure signal to reduce variations of the displacement control signal.

In the case where the generator is connected to the electric grid and the generator is directly driven by the hydraulic motor, e.g. the generator shaft is fixed to the shaft of the hydraulic motor, the motor operates at almost fixed rotational speed. In this embodiment of the invention the relationship between the speeds of the pump and motor is largely determined by the ratios of their displacement. However, due to oil leakage in the pump and/or motor this relationship is affected. The level of leakage flow is dependent on, and consequently increases with the hydraulic pressure which itself varies with the wind and turbine speeds. It is shown that this may lead to instabilities and oscillations in the system. The present invention may remedy this by further stabilising the control signal used for actuating the motor displacement by adding a new pressure control loop

In an embodiment of the invention the control loop comprises a high pass filter in order to avoid steady state variations of the hydraulic pressure in the hydrostatic transmission system to interfere with the turbine speed control loop.

Examples of embodiments of the invention will now be described in detail with reference to the accompanying drawings, in which:

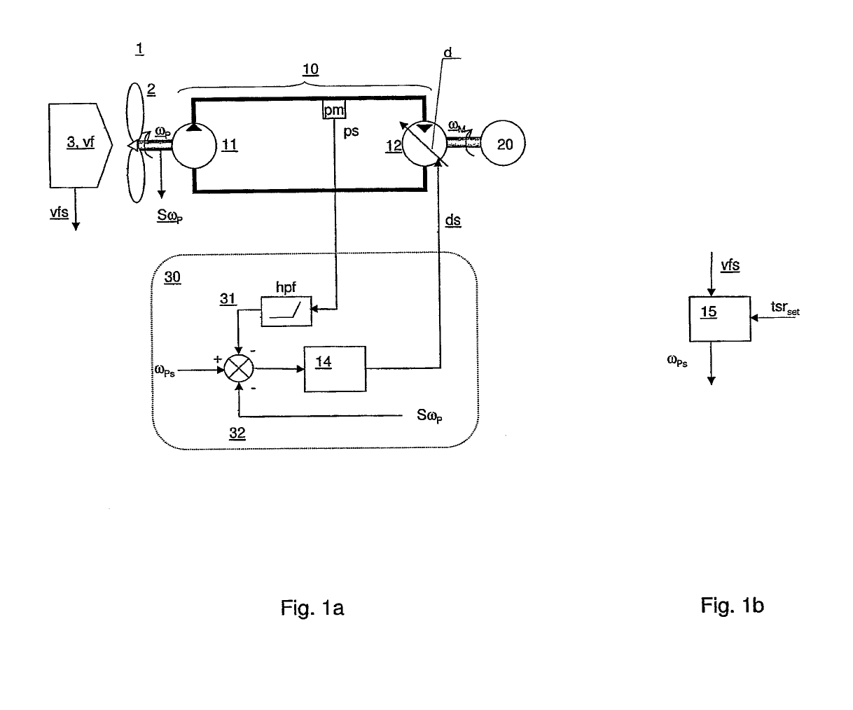

FIGS. 1a and 1b illustrate in a block diagrams a control system used in a turbine power production system with a closed loop hydrostatic system according to an embodiment of the invention

FIG. 2 illustrates in a diagram the normal variation of the turbine speed with the displacement where the generator speed is kept at a constant value. It also shows how the turbine speed may increase due to internal leakage in the hydrostatic transmission system.

FIG. 3 illustrates in a diagram how the hydraulic pressure may vary with the turbine speed and the wind speed and that the slope of the curves may vary considerably for the same turbine speed when the wind speed changes.

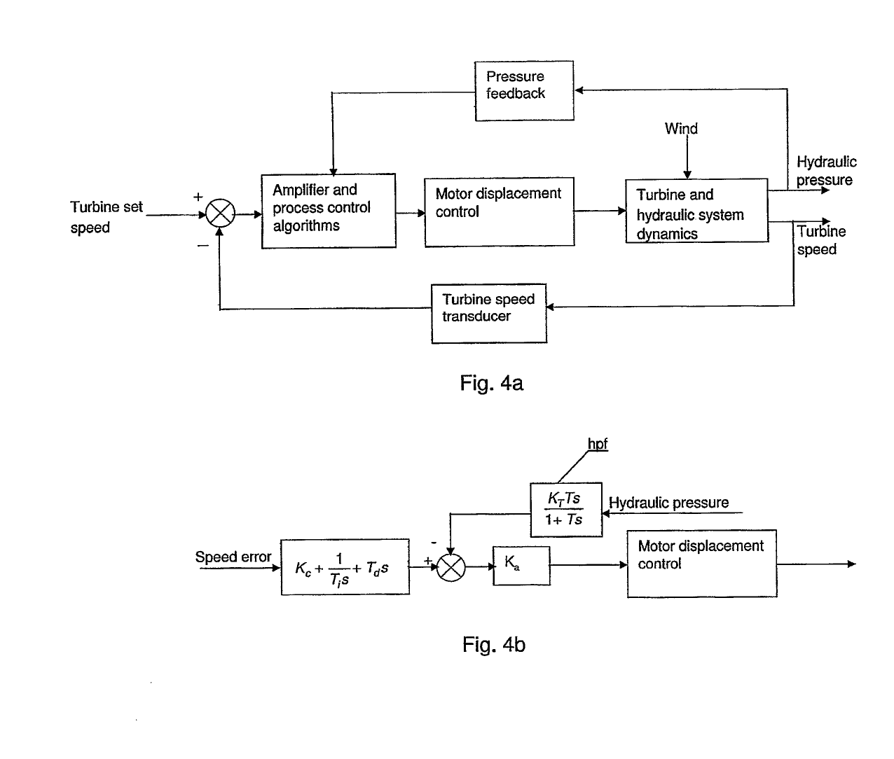

FIG. 4a illustrates in a block diagram a closed loop control system with turbine speed and pressure feedback according to an embodiment of the invention.

FIG. 4b is a representation of an implementation of the control system where a high pass filter is used to suppress steady state variations of the hydraulic pressure feedback.

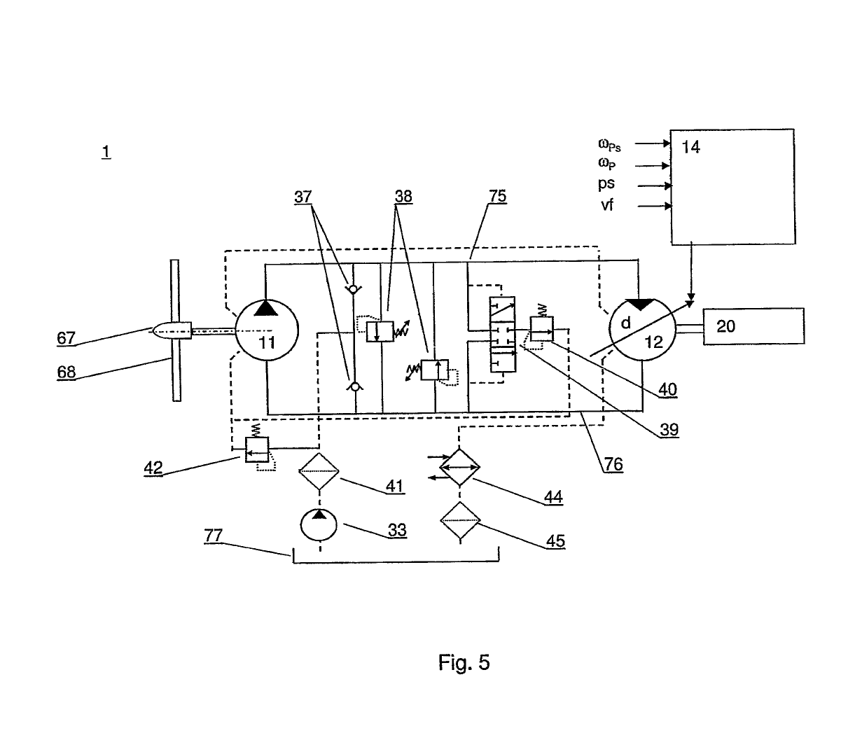

FIG. 5 is a diagram of a hydraulic transmission and control circuit according to an embodiment of the invention.

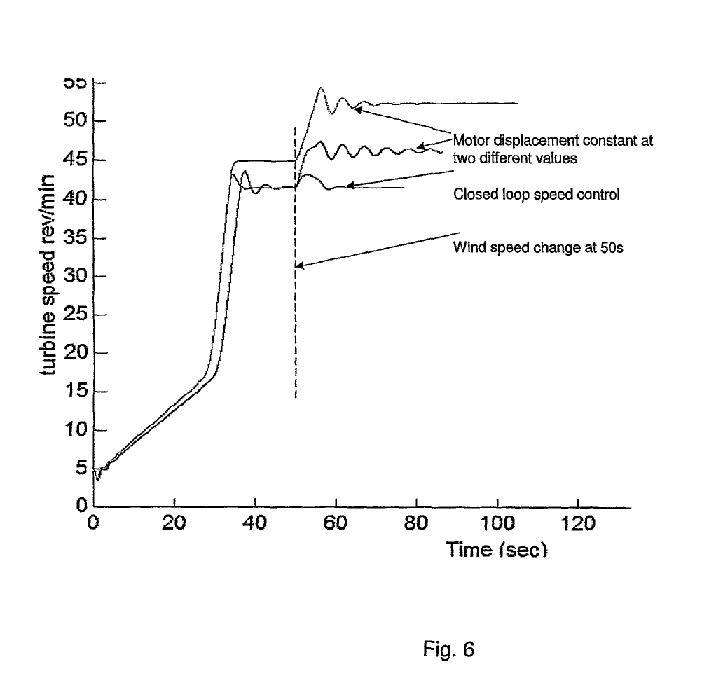

FIG. 6 illustrates the variation in turbine speed for a shift in wind speed.

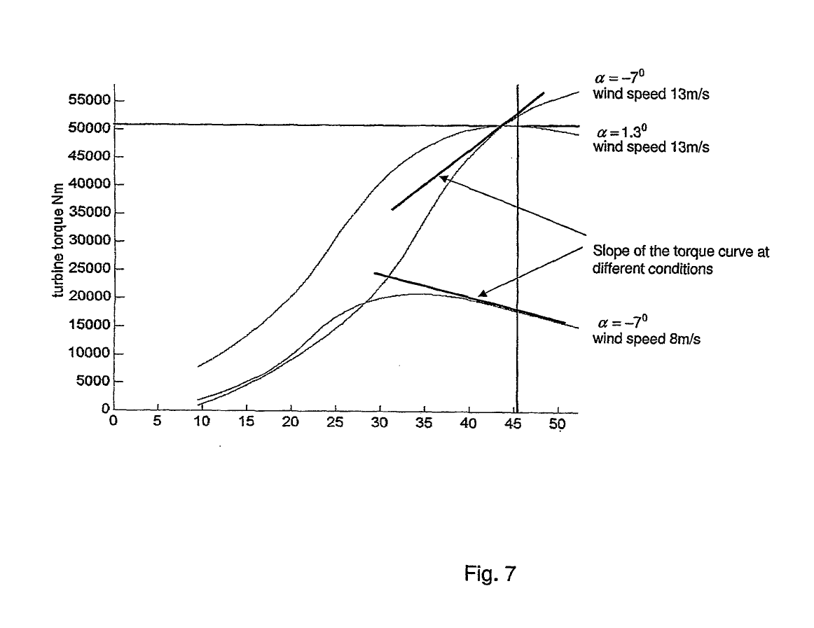

FIG. 7 illustrates in a diagram how the turbine torque varies with turbine speed and pitch angle of the turbine blades.

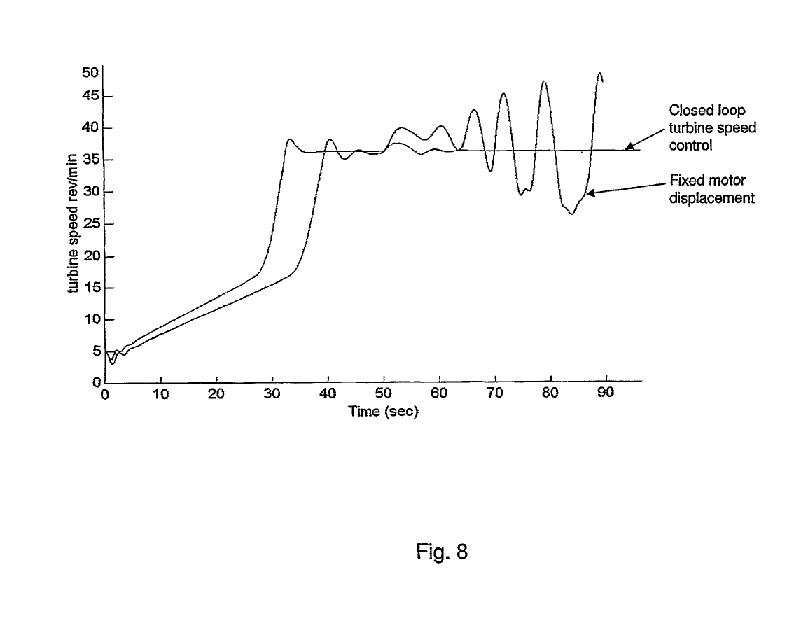

FIG. 8 illustrates in a diagram how the operating turbine speed has become unstable with fixed motor displacement and how the turbine speed may be stabilised with a control system according to an embodiment of the invention.

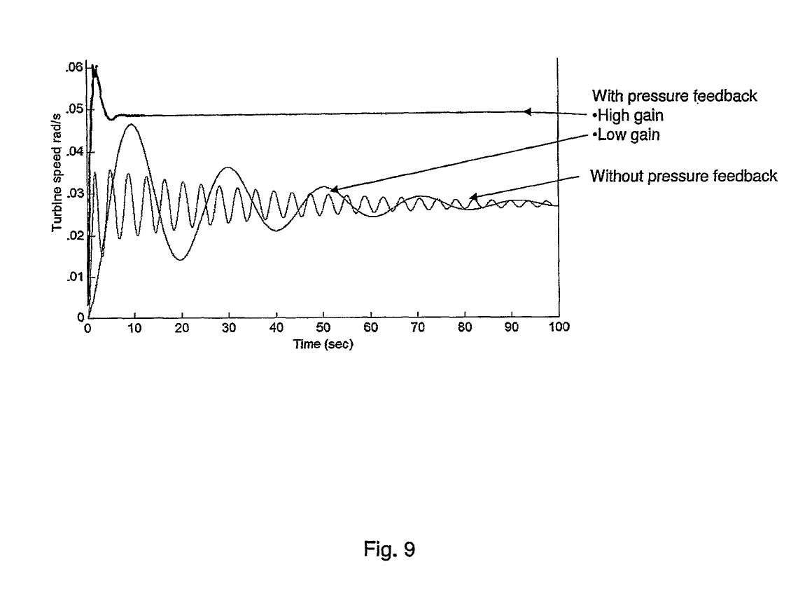

FIG. 9 illustrates in a diagram how the controlled steady state after a step change in turbine speed demand depends on the gain of the pressure feedback closed loop. It also illustrates the improvement in steady state for a control system according to an embodiment of the invention related to a speed control system without pressure feedback.

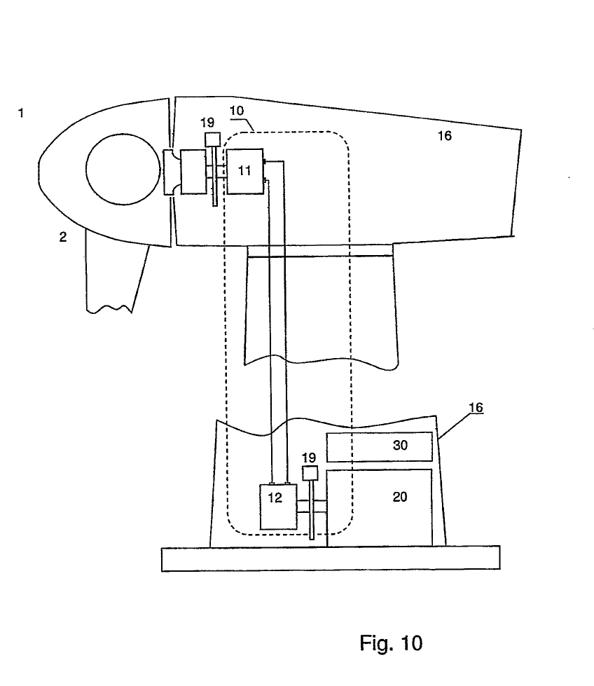

FIG. 10 illustrates a vertical section of a wind turbine power production system according to an embodiment of the invention where the hydraulic motor of the hydrostatic transmission system and the generator are located in the base of the tower or near the ground.

### EMBODIMENTS OF THE INVENTION

A number of embodiments of the invention will now be described referring to the attached figures.

Hydrostatic transmission systems are important in the development of new light-weight wind and water turbine systems. The advantages of being able to move the generator out of the nacelle to reduce the weight of the nacelle has been thoroughly described previously in this document.

In the case where the generator is connected to the electric grid and the generator is directly driven by the hydraulic motor, e.g. the generator shaft is fixed to the shaft of the hydraulic motor, the motor operates at almost fixed rotational speed and for this situation the turbine speed can be directly related to motor displacement as shown in FIG. 2, where it is shown that normal variation of the turbine speed with motor displacement for the motor speed kept at a constant value. Consequently, for a given displacement there is a particular ideal value of turbine speed e.g. at point A for the maximum displacement condition. However, as is shown in FIG. 2, as a result of internal leakage in the pump or in the motor, this value of turbine speed will increase to point B. The level of the leakage flow is dependent on, and consequently increases with, the hydraulic pressure which itself varies with the wind and turbine speeds as shown in FIG. 3. The leakage rate also increases with the temperature of the hydraulic fluid because of the reduction in the fluid viscosity. FIG. 3 also shows the pressure characteristics of the hydrostatic system in relation to the turbine speed and wind speed. As can be seen from the graphs the turbine speed giving maximum pressure (and corresponding torque) varies with the wind speed and the slope of the turbine speed/pressure curve may change from positive to negative values. This behaviour may create oscillations or undesired variations in the system.

The block diagram in FIG. 4a shows the basic elements of the turbine rotational speed control system in an embodiment of the invention whereby the measured turbine rotational speed is fed back and compared with the set speed. When the measured speed is greater than the set speed the negative output (error signal) causes a reduction in motor displacement.

FIG. 4a further shows the pressure feed back control loop, enabling the system damping to be increased so that the proportional gain can itself be increased to a level that gives only a small change in turbine speed with changes in hydraulic pressure (turbine torque).

In an embodiment, the present invention, as illustrated in FIG. 1a, is a closed loop turbine rotational speed control system (30) for a turbine power production system (1) arranged for being driven by a fluid (3). The turbine power production system comprises a closed loop hydrostatic transmission system (10) for the transfer of energy from a wind turbine rotor (2) to an electric generator (20), wherein said hydrostatic transmission system (10) comprises a pump (11) and a variable displacement motor (12). Further it comprises a displacement actuator (d) arranged for receiving a displacement control signal (ds) from said turbine speed control system (30) and for controlling a displacement of the displacement motor (12) based on the control signal (ds). A hydraulic pressure meter (pm) is arranged for measuring a hydraulic pressure of the hydrostatic system (10) and providing a hydraulic pressure signal (ps).

The closed loop turbine rotational speed control system (30) comprises a turbine rotor rotational speed feedback control loop (32) arranged for calculating the displacement control signal (ds) based on deviations of a turbine rotor actual rotational speed (ωp) from a turbine rotor set rotational speed (ωₚₛ). The closed loop turbine rotational speed control system (30) further comprises a pressure feedback control loop (31) stabilising said turbine rotor actual rotational speed (ωp) based on the hydraulic pressure signal (ps).

Further, in an embodiment the invention is a method for controlling a turbine rotational speed (ωₚ) of a turbine power production system (1) driven by a fluid (3) wherein the turbine power production system comprises a closed loop hydrostatic transmission system (10) for the transfer of energy from a wind turbine rotor (2) to an electric generator (20). The hydrostatic transmission system (10) comprises a pump (11), a variable displacement motor (12) and a displacement actuator (d) receiving a displacement control signal (ds) from the turbine speed control system (30) and controlling a displacement of the displacement motor (12) based on the control signal (ds). The method comprises the following steps;
setting a turbine set rotational speed (ωₚₛ),
measuring a turbine actual rotational speed (ωₚ) and providing a turbine actual rotational speed signal (Sωₚ),
measuring a hydraulic pressure (p) of the hydrostatic system (10) and providing a hydraulic pressure signal (ps),
calculating (preferably continuously) the displacement control signal (ds) based on a difference in the turbine set rotational speed (ωₚₛ) and the turbine actual rotational speed signal (Sωₚ), and
stabilising (preferably continuously) the turbine rotor actual rotational speed (cop) based on the hydraulic pressure signal (ωs) to reduce variations of the displacement control signal (ds).

The steady-state and dynamic performance of the control system depends on the slope of the control line in FIG. 2 where the maximum slope of the control line is limited by the stability of the closed loop control system. In order to reduce this stability limitation compensating elements are provided in the amplifier block of FIG. 4a that modify the proportional speed control action.

The use of pressure feed back enables the system damping to be increased so that the proportional gain can itself be increased to a level that gives only a small change in turbine speed with changes in hydraulic pressure (turbine torque). As an alternative the proportional gain can be replaced with proportional plus integral algorithm (PID) compensator, lead/lag or phase advance compensation algorithms which may or may not be such that the pressure feedback is not required.

In the case where the generator is connected to the electric grid and the generator (20) is directly driven by the hydraulic motor (12), e.g. the generator shaft is fixed to the shaft of the hydraulic motor (12), the motor (12) operates at almost fixed rotational speed. In this embodiment of the invention the relationship between the speeds of the pump (11) and motor (12) is largely determined by the ratios of their displacement. However, due to oil leakage in the pump and/or motor this relationship is affected. The level of leakage flow is dependent on, and consequently increases with the hydraulic pressure which itself varies with the wind (vf) and turbine (ωₚ) speeds. It is shown that this may lead to instabilities and oscillations in the system. Embodiments of the present invention may remedy this by further stabilising the control signal used for actuating the motor displacement by adding a new pressure control loop.

In an embodiment of the invention the control loop comprises a high pass filter (hpf), as seen in FIG. 1a and FIG. 4b, in order to avoid steady state variations of the hydraulic pressure in the hydrostatic transmission system to interfere with the turbine speed control loop. In FIG. 1a the block (14) denotes the additional functional blocks of the control system (30). This is detailed in FIG. 4a and FIG. 4b where it is also seen that the to system dynamics of the turbine and hydraulic system influence the control loops.

The control algorithms are contained in the ‘amplifier and process control algorithms’ block in FIG. 4a and these would typically consist of the elements shown in FIG. 4b.

In an embodiment of the invention the power production system (1) is a wind turbine power production system and the pump (11) is arranged in a nacelle (16), and the variable displacement motor (12) and the generator (20) are arranged below the nacelle (16) as illustrated in FIG. 10. The control system (30) may be arranged near the ground, in the nacelle, or arranged as a distributed control system in the nacelle (16) and tower (17). In an embodiment where the power production system is installed off-shore or near-shore, the variable displacement motor (12), and the generator (20) may be arranged near the sea-surface or below the sea surface.

In an embodiment of the invention the closed loop turbine rotational speed control system (30) is arranged for receiving a speed signal (vfs) as shown in FIG. 1b, representing a speed (vf) of said fluid (3) and further arranged for calculating said turbine set rotational speed (coₚₛ) in a TSR function (15), so as for enabling to maintain a set turbine tip speed ratio (tsrₛₑₜ) and thereby achieving an improved power efficiency of the power production system (1) during fluctuations in said fluid speed (v1). Preferably, the system is arranged for receiving continuously the speed signal (vfs).

As has already been mentioned the speed control will act to prevent speed variations that arise due to changes in turbine speed as a result of internal leakage.

FIG. 6 shows the simulated variation in turbine speed during a start-up at a wind speed of 8 m/s followed by an increase in wind speed to 14 m/s. When operating at fixed motor displacement it can be seen that the operating speed is higher than the speed that is obtained when the turbine speed is controlled in a closed loop. This has been caused by the leakage increasing with increasing load pressure.

Simulation studies show that oscillations can be created by the torque characteristics of the turbine in relation to the turbine speed (e.g. positive slope torque curve). The variation in the operating slope with wind speed of the torque speed characteristic is shown in FIG. 7 for the turbine operating at a fixed speed.

Oscillations in speed for operation at fixed motor displacement can be seen in FIG. 6 which are due to the slope of the torque/speed characteristic. This effect can be greater in other conditions as shown in FIG. 8 where the operating turbine speed has become unstable with fixed motor displacement.

An example of the benefits of a control system according to an embodiment of the present invention is shown in FIG. 9. For a step change in speed demand of 0.05 rad/s the controlled steady state value will depend on the closed loop gain. Without pressure feedback the value of this gain is limited by the stability of the system.

From FIG. 9 it is seen that without pressure feedback the response is very oscillatory with a steady state value of 0.027 for a step change of 0.05. With pressure feedback the steady the gain can be increased as seen in FIG. 9 which reduces the oscillations and increases the steady state value to 0.0485 (0.97 accuracy).

FIG. 5 illustrates schematically the elements of the wind power production system (1) together with the hydraulic elements and the elements of the control systems in an embodiment of the invention.

The hydraulic fixed displacement pump (11) is connected to a variable displacement hydraulic motor (12) by a supply pipe (75) and a return pipe (76). The hydraulic fluid required by the hydrostatic system to replace fluid that is lost to external leakage is supplied by pump (33) from a reservoir (77).

The pump (11) and the motor (12) are arranged as a closed circuit hydrostatic system (10), which may be boosted by flow from the reservoir by pump (33). The circuit contains elements for controlling pressure and cooling flow for the pump (11) and motor (12). The turbine hub (67) contains the mounting for the blades (68), the angle (αₚ) of which may be adjusted by an actuator controlled by a pitch control subsystem where this is required. Flow for this purpose may be taken from the pump (11) as may be any flow required to operate the brakes (not indicated).

The motor displacement control subsystem (14) serves to provide control signals (ds) to the motor displacement actuator (d) for varying the motor displacement in accordance with the requirement to control the displacement of the motor (12) in order to indirectly control either the rotational speed (ωₚ) of the turbine (2) and/or to directly control the rotational speed (ω_{P}) of the motor (12).

The pressure output from booster pump (33) is controlled by a relief valve (42) and takes its flow from the reservoir through filter (41). This pressurised flow is passed into the low-pressure side of the hydrostatic circuit (10) by means of either of the check valves (37). Flow from the relief valve (42) is taken through the casings of the pump (11) and motor (12) for the purposes of cooling these units. Flow can also be extracted from the high pressure circuit by means of the purge valve (39) and the relief valve (40), this flow being added to the cooling flow into the casing of pump (11). The cooling flow from the casing of motor (12) is passed through the cooler (44) and filter (45) after which it is returned to the reservoir (77). Under conditions when the hydrostatic system pressure exceeds a predetermined value, either of the relief valves (38) will open to pass flow to the low-pressure side of the hydrostatic system.

For the improvement of the dynamic performance of the speed control and its stability, compensation techniques as known by a person with ordinary skills in the art can be applied to the motor displacement control system. These include the feedback of the hydraulic pressure and the use of PID (proportional, integral and derivative) control circuits that will allow the system gain to be increased which will improve the damping and steady state accuracy.

Embodiments of the present invention have been described with particular reference to the examples illustrated. However, it will be appreciated that variations and modifications may be made to the examples described within the scope of the present invention.

1-12. (canceled)

13. A closed loop turbine rotational speed control system for a turbine power production system arranged for being driven by a fluid, said turbine power production system comprises a closed loop hydrostatic transmission system for the transfer of energy from a wind turbine rotor to an electric generator, wherein said hydrostatic transmission system comprises:
a pump;
a variable displacement motor; and
a displacement actuator arranged for receiving a displacement control signal from said turbine speed control system and further arranged for controlling a displacement of said displacement motor based on said control signal,
wherein said closed loop turbine rotational speed control system comprises a turbine rotor rotational speed feedback control loop arranged for calculating said displacement control signal based on deviations of a turbine rotor actual rotational speed from a turbine rotor set rotational speed, and
wherein a hydraulic pressure meter is arranged for measuring a hydraulic pressure of said hydrostatic system and providing a hydraulic pressure signal, and said closed loop turbine rotational speed control system further comprises a pressure feedback control loop arranged for stabilizing said turbine rotor actual rotational speed based on said hydraulic pressure signal.

14. The closed loop turbine rotational speed control system of claim 13, wherein said generator operates at a constant rotational speed.

15. The closed loop turbine rotational speed control system of claim 13, further comprising a high pass filter arranged for suppressing the effects of steady state variations of said hydraulic pressure signal.

16. The closed loop turbine rotational speed control system of claim 13, wherein said power production system is a wind turbine power production system and wherein said pump is arranged in a nacelle and said variable displacement motor and said generator are arranged below said nacelle.

17. The closed loop turbine rotational speed control system of claim 13, further arranged for continuously receiving a speed signal representing a speed of said fluid and further arranged for calculating said turbine set rotational speed, so as for enabling to maintain a set turbine tip speed ratio and thereby achieving an improved power efficiency of the power production system during fluctuations in said fluid speed.

18. A method for controlling a turbine rotational speed of a turbine power production system driven by a fluid, wherein said turbine power production system comprises a closed loop hydrostatic transmission system for the transfer of energy from a wind turbine rotor to an electric generator, wherein said hydrostatic transmission system comprises a pump, a variable displacement motor and a displacement actuator receiving a displacement control signal from said turbine speed control system and controlling a displacement of said displacement motor based on said control signal, comprising the following steps;
setting a turbine set rotational speed;
measuring a turbine actual rotational speed and providing a turbine actual rotational speed signal;
continuously calculating said displacement control signal based on a difference in said turbine set rotational speed and said turbine actual rotational speed signal;
measuring a hydraulic pressure of said hydrostatic system and providing a hydraulic pressure signal; and
continuously stabilizing said turbine rotor actual rotational speed based on said hydraulic pressure signal to stabilize said displacement control signal.

19. The method according to claim 18, further comprising the step of operating said generator at a constant rotational speed.

20. The method according to claim 18, further comprising the step of high-pass filtering said hydraulic pressure signal to suppress steady state variations of said hydraulic pressure signal before modifying said displacement control signal.

21. The method according to claim 18, wherein said power production system is a wind turbine power production system and wherein said pump is arranged in a nacelle and said variable displacement motor and said generator are arranged below said nacelle.

22. The method according to claim 18, further comprising the steps of continuously calculating the turbine rotor set rotational speed based on a fluid speed, so as for enabling to maintain a set turbine tip speed ratio and thereby achieving an improved power efficiency of the power production system during fluctuations in said fluid speed.
